(19) United States
(12) Patent Application Publication
(10) Pub. No.: US 2011/0242042 A1
(43) Pub. Date: Oct. 6, 2011

(54) Touch Panel Having Joystick Capabilities

(75) Inventor: Lin Xu, Shanghai (CN)

(73) Assignee: AMLOGIC CO., LTD., Santa Clara, CA (US)

(21) Appl. No.: 12/753,800

(22) Filed: Apr. 2, 2010

(51) Int. Cl. G06F 3/045; G06F 3/041

(52) U.S. Cl. 345/174; 345/173

(57) ABSTRACT

A method for operating a touch panel comprises the steps of: sensing an object in proximity to the touch panel; determining a location on the touch panel corresponding to the sensed object; determining a contact metric indicative of an amount of pressure applied on the touch panel by the sensed object; and operating the touch panel as a function of the location and the contact metric.

### FIELD OF INVENTION

This invention relates to a touch panel, and, in particular, to methods for operating a touch panel having pressure-sensing and joystick capabilities.

### BACKGROUND

Various devices are well known for controlling cursor movement on a display screen of a computer and for signaling a command/application identified by the position of the cursor on the display screen. The most commonly known device is known as a mouse, which can have an optical sensor (or rolling ball mechanism) on its underside to sense movement and one or more buttons located at the top of the mouse. The amount and direction of movement of the mouse can cause the cursor on the display screen to have a corresponding movement. Furthermore, the buttons can be selected to signal a selection based on the location of the cursor. The sensed data can be transmitted to the computer through a connecting cable to a serial input port of the computer.

Unfortunately, the mouse does not offer a compact and robust method for user input since the mouse requires a substantially flat and horizontal surface to sense the movement of the mouse. Furthermore, the surface must be large enough to allow the user to slide the mouse for proper operation. Even when suitable space is provided, the user may not desire using the mouse since it requires a dedicated hand to operate it. This can be especially problematic when the user is using another device simultaneously (e.g., a keyboard), which requires the user to expend additional time by physically switching between operating the mouse and operating the device.

Another well known electrical controlling and signaling mechanism is a joystick. FIG. 1 illustrates a prior art apparatus for a joystick. A joystick is a hand-held input device usually comprising an elongated stick 10 and one or more buttons (e.g., buttons 20, 22, and 24), where the elongated stick 10 pivots on a base 12. The joystick can be connected to a computer by means of a cable (not shown).

The joystick is operated by tilting the stick 10 in various directions to cause a display element (e.g., a cursor) to move in a direction and at a speed corresponding to the direction of the stick. The one or more buttons can be pressed to signal a selection corresponding to the location of the display element on the display screen.

Combining stick movement and button presses with timing information, the joystick can be used to distinguish various user inputs, such as a single button click, double button clicks, a button holds after a click, a stick movement in a direction, and the amount of time the stick is held toward a direction. Due to the diverse functionality, the joystick can be used to replace a mouse for web browsing since the joystick can direct a display element to a desired location by moving the stick in a direction to move the cursor accordingly. When the display element reaches the desired location, a user can return the stick to a neutral position to stop the display element from moving and select an associated command with the desired location using a button of the joystick. Furthermore, the joystick may also be preferred over a mouse since the joystick may only need a relatively small space to operate properly, whereas a mouse may need a relatively larger space to operate properly.

However, known joysticks of such a type utilize internal mechanisms that result in a relatively bulky base and a mechanical biasing force on the stick to place the stick in a neutral position. Furthermore, the stick may require a large amount of vertical space to allow for the stick to move freely. Thus, it is desirable to provide methods and apparatuses for a joystick which can minimize the amount of space needed for operating the joystick.

Joysticks and computer keyboards have been combined in various manners by having a pointing stick placed in the middle of a keyboard. Typically, the pointing stick comprises a very short stick, which is usually a rubber cap, and a pair of resistive strain gauges to detect when the stick is moved. As a user operates the keyboard, the user can place a finger on the short stick to operate the cursor on the display screen. The pointing stick can sense applied force through the pair of resistive strain gauges and then translate that applied force to a cursor movement on the display screen. The velocity of the cursor can depend on the amount of applied force sensed by the resistive strain gauges.

Unfortunately, due to the mechanical nature of having to exert physical force to move the pointing stick towards a direction, the pointing stick may be permanently bent, which can result in cursor drift. Cursor drift is a ubiquitous problem among pointing sticks, which requires frequent repairs. Furthermore, the structural design, the material's life time, and the cost in manufacturing these joysticks are also drawbacks of the pointing stick.

Therefore, it is desirable to provide a joystick apparatus and methods for operating the joystick apparatus, where the amount of space needed to operate the joystick is reduced and where the joystick is more robust.

### SUMMARY OF INVENTION

An object of this invention is to provide methods for calculating a vector for a detected object on or in proximity to a touch panel and for using the vector to implement joystick capabilities using the touch panel.

Another object of this invention is to provide methods for determining a contact metric for a detected object on or in proximity to a touch panel, where the contact metric is indicative of the amount of pressure exerted on the touch panel by the detected object.

Yet another object of this invention is to provide methods for operating a touch panel, where a user can operate the touch panel from a finger-sized area.

Briefly, the present invention discloses a method for operating a touch panel, comprising the steps of: sensing an object in proximity to the touch panel; determining a location on the touch panel corresponding to the sensed object; determining a contact metric indicative of an amount of pressure applied on the touch panel by the sensed object; and operating the touch panel as a function of the location and the contact metric.

An advantage of this invention is that methods are provided for calculating a vector for a detected object on or in proximity to a touch panel and for using the vector to implement joystick capabilities using the touch panel.

Another advantage of this invention is that methods are provided for determining a contact metric for a detected object on or in proximity to a touch panel, where the contact metric is indicative of the amount of pressure exerted on the touch panel by the detected object.

Yet another advantage of this invention is that methods are provided for operating a touch panel, where a user can operate the touch panel from a finger-sized area.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a prior art apparatus for a joystick.

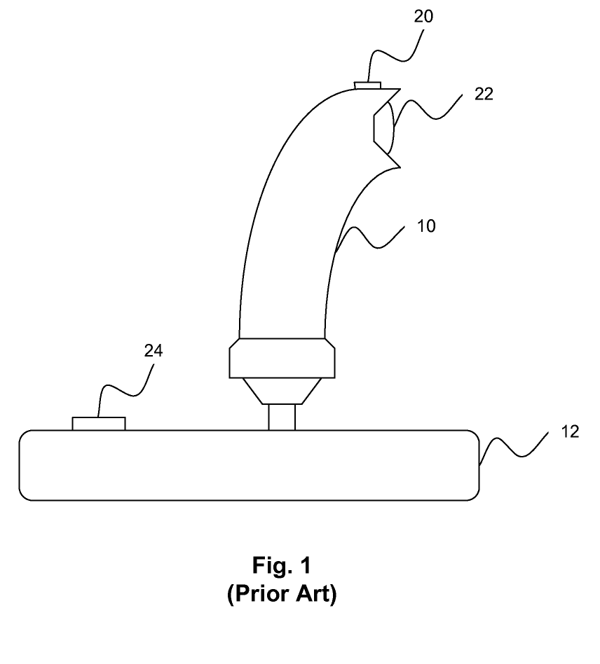

FIG. 2 illustrates a user's hand operating a touch panel of the present invention having joystick capabilities.

FIG. 3 illustrates a PCB layout for implementing a touch panel of the present invention having joystick capabilities.

FIG. 4 illustrates a PCB layout with a defined active detection area for implementing a touch panel of the present invention having joystick capabilities.

FIG. 5 illustrates a block circuit diagram for implementing a touch panel of the present invention having joystick capabilities.

FIG. 6 illustrates a mapping scheme for an active detection area of a touch panel of the present invention having joystick capabilities.

FIG. 7 illustrates another mapping scheme for an active detection area of a touch panel of the present invention having joystick capabilities.

### DETAILED DESCRIPTION OF THE PREFERRED EMBODIMENTS

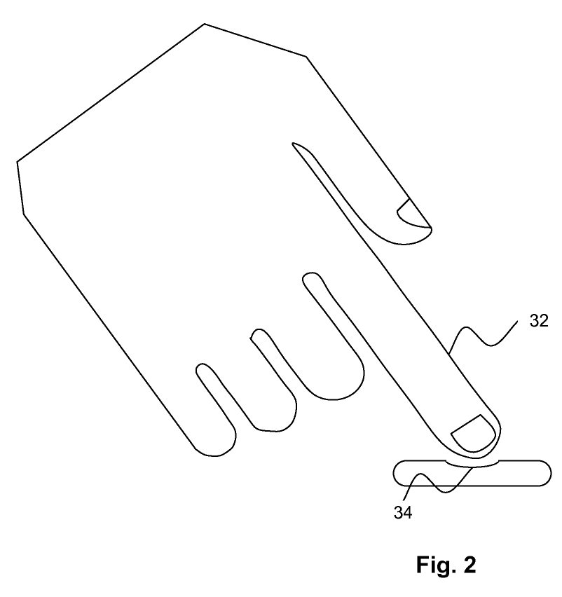

FIG. 2 illustrates a finger in proximity to a touch panel of the present invention having joystick capabilities. An object (e.g., finger 32) can touch (or be in close proximity to) an active detection area 34 of a touch panel to operate the touch panel. The active detection area 34 can be identified by a marking on the cover of the touch panel or by a guide having a distinctive shape (e.g., a concave shape) on the cover of the touch panel.

The touch panel can collect various data based on user input. For instance, the touch panel can collect vector information (i.e., an angle and a distance from a predefined position on the touch panel) of a detected object, a contact metric for indicating the amount of contact between the object and the touch panel, the amount of time the vector is maintained on the touch panel, the amount of time the contact metric is maintained on the touch panel, and other data relating to the detected object.

In general, the touch panel can be implemented by a capacitive touch panel having the following capabilities. The capacitive touch panel can provide an object's location along the touch panel and a contact metric according to a capacitance measurement of the touch panel.

Thus, a touch panel having a relatively small active detection area (e.g., around the size of a finger) can be used in the present invention. However, it is understood that the following examples are used to aid in illustrating the core concepts of the present invention, but the invention is not limited to the following examples since other embodiments can be used to implement the touch panel of the present invention.

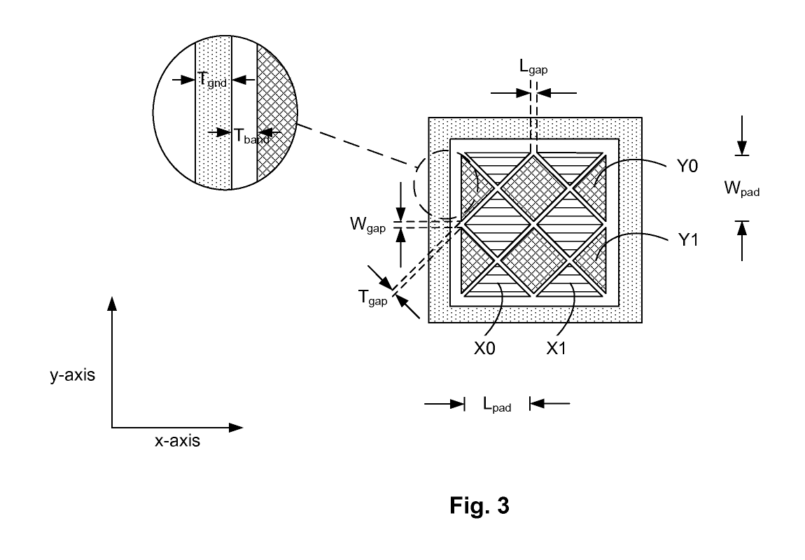

FIG. 3 illustrates a printed circuit board (“PCB”) layout for implementing a touch panel of the present invention having joystick capabilities. A touch panel can have two channels X0 and X1 (positioned perpendicular to an x-axis and can be generally referred to as the X-channels) and two channels Y0 and Y1 (positioned perpendicular to a y-axis and can be generally referred to as the Y-channels). The X-channels are perpendicular to the Y-channels forming a grid across a rectangular touch panel for detecting an object touching or in proximity to the touch panel. Each channel is connected to a capacitance touch sensor (not shown) for determining the amount of capacitance for the channel. These channels can be referred to as capacitance touch sensing channels or capacitance channels. A channel can comprise multiple diamond shaped touch pads and triangle shaped touch pads connected together.

The channels X0 and X1 are positioned along parallel rows to each other for determining the x-axis location of an object that is touching or in proximity to the touch panel. The channel X0 can have a diamond-shaped touch pad and two half diamond-shaped touch pads connected together to form the channel X0. Likewise, channel X1 can be formed in a similar pattern. It is important to note that the number of touch pads per channel and the number of X-channels can vary depending on the sensitivity of the remote controller and the physical size of the touch panel.

The channels Y0 and Y1 are positioned along parallel rows to each other for determining the y-axis location of the object that is touching or in proximity to the touch panel. The channel Y0 can have a diamond-shaped touch pad and two half diamond-shaped touch pads connected together to form the channel. Likewise, the channel Y1 can be formed in a similar pattern. It is important to note that the number of touch pads per channel and the number of Y-channels can vary depending on the sensitivity of the remote controller and the physical size of touch panel. Since the touch panel can have joystick capabilities, a two-channels-by-two-channels grid can be used to implement the functionality of the touch panel.

The diamond-shaped touch pads of the channels can be of the same size, preferably, the width of the touch pad (“Wpad”) is 8 mm and the length of the touch pad (“Lpad”) is 8 mm. The half diamond-shaped touch pads are ½ the size and shape of a diamond-shaped pad, thus resembling a triangle shape. Preferably, there is a gap between touch pads of adjacent X-channels (“Lgap”) of about 0.7 mm and a gap between touch pads of adjacent Y-channels (“Wgap”) of about 0.7 mm. Furthermore, the interspacing between any two touch pads within the grid of channels (“Tgap”) is about 0.5 mm.

In order to form a single channel, the touch pads of the single channel can be laid on a top side of a PCB with at least the Tgap distance separating the touch pads. Since the touch pads of the single channel need to be connected to form the channel, the touch pads can be connected via connections on a bottom side of the PCB or on the top side of the PCB.

The grid of X-channels and Y-channels is surrounded by a gap having a thickness (“Tband”), where Tband is preferably of about 1 mm. A grounding wire further surrounds the boundary of the gap. The thickness of the grounding wire (“Tgnd”) is preferably no less than 1 mm.

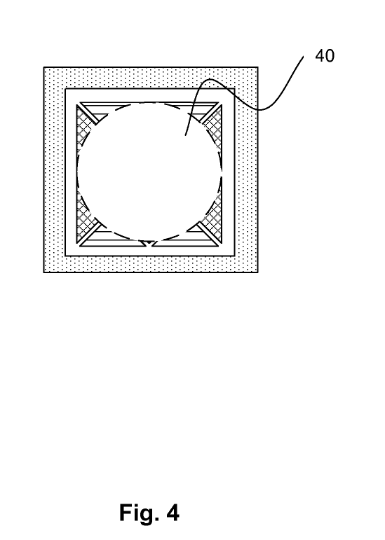

FIG. 4 illustrates a PCB layout with a defined active detection area for implementing a touch panel of the present invention having joystick capabilities. The touch panel can have an active detection area 40 defined on the touch panel. The active detection area can be formed in various shapes, but is preferably defined by a circular shape. Furthermore, the active detection area can be mapped to a two dimensional coordinate system, where the center of the shape can form the origin (0, 0) of the coordinate system.

When an object is detected directly over the active detection area, the touch panel can register the touch as a valid touch for processing. For valid touches, the touch panel can associate a user input command. However, if the object is outside the active detection area, then the touch panel can register the touch as an invalid touch. For invalid touches, the touch panel need not process the detected object.

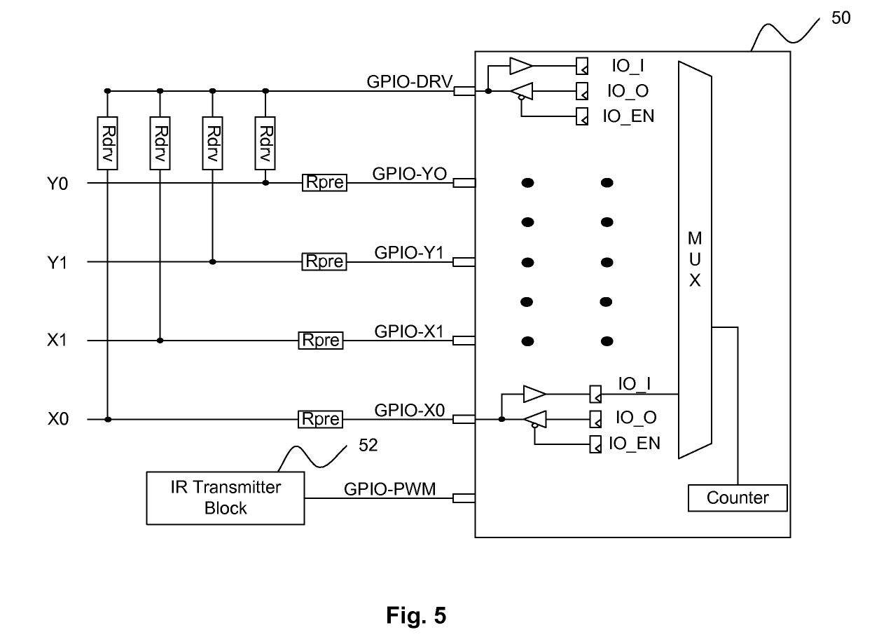

FIG. 5 illustrates a block circuit diagram for implementing a touch panel of the present invention having joystick capabilities. A controller 50 can have a general purpose input/output (“GPIO”) pin connected to each of the four capacitance touch sensing channels Y0, Y1, X0, and X1, thus having a total of four GPIO pins for reading the X-channels and Y-channels.

For each of the channels Y0, Y1, X0, and X1, the channel is connected to a first terminal of a serial-in resistor, Rpre, which is preferably 10K ohms, to provide current limitation. A second terminal of the Rpre resistor is connected to the corresponding GPIO pin for the channel.

The controller can also have a GPIO pin (“GPIO_DRV”) for common drive purposes. This common drive connects to the four capacitance sensing channels Y0, Y1, X0, and X1 through four serial-in resistors, Rdrv, which are preferably 10M ohms each, for further current limitation of a small amount. Additionally, the controller can have another GPIO pin (“GPIO-PWM”) for driving an IR transmitter block 52.

The basic theory behind capacitance touch sensing channels can be found in the co-pending United States non-provisional patent application having the application Ser. No. 12/646,952, which was filed on Dec. 23, 2009 and entitled, “A Remote Controller Having A Touch Panel For Inputting Commands.”

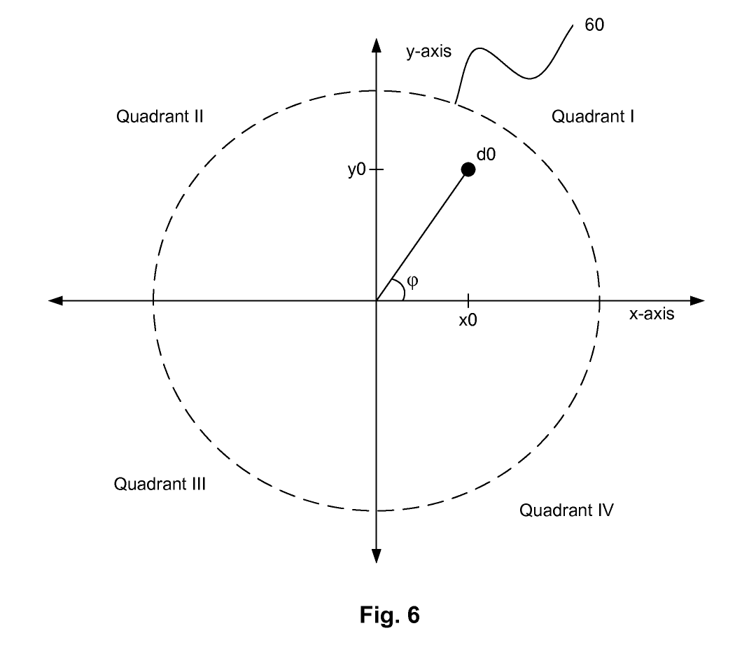

FIG. 6 illustrates a mapping scheme for an active detection area of a touch panel of the present invention having joystick capabilities. An active detection area 60 can have a circular shape, where the active detection area 60 is mapped to an x-y coordinate system. The x-y coordinate system can be further partitioned into four different quadrants: quadrant I, where both x and y values are positive; quadrant II, where an x value is negative and a y value is positive; quadrant III, where both x and y values are negative; and quadrant IV, where an x value is positive and a y value is negative. Thus, when an object is directly over the active detection area 60, the location of the object on the active detection area 60 from an origin location can be calculated. This location can have a distance d0 from the origin. The distance d0 can be calculated by the x0 component and the y0 component for the detected object. Given the location information, an angle φ can be calculated by generally known trigonometric analysis.

With the mapping of the active detection area 60 of the touch panel to the x-y coordinate system, the location of an object on the active detection area 60 can be found through the following algorithm. For the purposes of simplifying the calculation, it can be assumed that the active detection area 60 is a circle having a radius of 8 mm and the origin (0, 0) of the x-y coordinate system corresponds to the center of the circle. It is understood that the shape of the active detection area can be of various size, thus altering the radius of the active detection area accordingly. Thus, when the object is pressed on the active detection area 60, the object can increase the capacitance of the capacitance channels X0, X1, Y0, and Y1. Furthermore, the extra capacitance introduced to X0, X1, Y0 and Y1 can be measured and denoted as Cx0, Cx1, Cy0 and Cy1, respectively.

Once the capacitance values are determined, the distance d can be calculated according to the following equations:

x=(−8*Cx0+8*Cx1)/(Cx0+Cx1), where x ranges from −8 mm to 8 mm; and (1)

y=(−8*Cy0+8*Cy1)/(Cy0+Cy1), where y ranges from −8 mm to 8 mm. (2)

Thus, a vector V can be defined from the origin (0, 0) to (x, y).

The angle φ of V from the x-axis can be calculated for a vector located in quadrant I or II by

φ=arctan(y/x), where φ ranges from 0 to π. (3)

The angle φ of V from the x-axis can be calculated for a vector located in quadrant III or IV by

φ=arctan(y/x)−π, where φ ranges from 0 to −π. (4)

Furthermore, the distance d of V can be found from the x and y values with the following equation,

d=(x²+y²)^{0.5}, where d ranges from 0 mm to 8 mm. (5)

The contact metric, W, can be calculated in terms of the total capacitance contributed by the object, such that

W=Cx0+Cx1+Cy0+Cy1. (6)

A plastic layer (e.g., a PMMA layer) can be used to cover the touch panel of the present invention. Furthermore, it can be assumed that the plastic layer may have a dielectric constant of around e=5.6 for a thin layer of around 0.5 mm over the active detection area. The cover may be thicker around the area outside the active detection area. The two electrodes for the touch panel can be one of the capacitive touch sensor channels X0, X1, Y0, and Y1 and an object pressed on the surface above the plastic cover. Thus, every 1 mm² of contacted acreage (i.e., surface contact on the plastic cover by the object over the active detection area) can cause an extra capacitance of 0.1 pF. Note that the active detection area can be roughly 200 mm²(π*8 mm*8 mm). Therefore, the contact metric W may range from 0 pF to 20 pF, with a distinguishable unit step of 0.1 pF. Thus, the resolution for W can be 200. In other words, the touch panel can detect 200 distinct levels for W.

Now, for any detection of an object touching or in close proximity to the touch panel of the present invention, a vector V, a distance d, and an angle φ can be found, where φ ranges from −πto π and d ranges from 0 mm to 8 mm. With a reasonable unit step of 1 mm, d may have a very limited resolution of 8, whereas the contact metric W with a higher resolution of 200 is 25 times higher than d.

In addition, preferably, the capacitance Cx0, Cx1, Cy0, and Cy1 can be measured at a frequency of 100 Hz (i.e., around 10 mS). With each round of measurements, the values φ, d, and W can also be calculated. Additionally, the timing data for an amount of time that the object is at a certain angle, a certain location, and/or a certain contact metric can also be used to distinguish between different user inputs. Additionally, a software filter can be used for anti-shocking or other similar purposes.

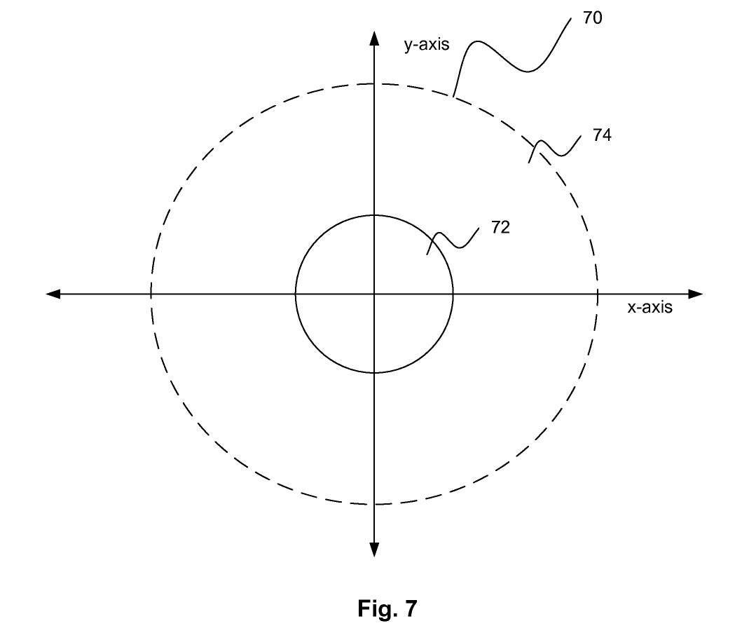

FIG. 7 illustrates another mapping scheme for an active detection area of a touch panel of the present invention having joystick capabilities. The active detection area 70 can be partitioned into two areas, a first area 72 and a second area 74. The first area can be used to receive a button command, whereas the second area can be used to receive a joystick control command. Thus, if an object is directly over or touching the second area, then the values of φ, D, and W can be calculated for the detected object to determine the associated joystick command. However, if the object is directly over the first area, a button command can be signaled. The location of the area or areas for receiving the button command can be distributed at the corners of the touch panel as well as other locations.

With the following variables x, y, d, and W calculated for a detected object, various user inputs can be determined according to specific combinations of the calculated variables. For instance, button oriented behaviors can be analyzed including single click, double click, an amount of hold after a click, sliding behaviors in a direction, and a wide range of cursor speeds according to the pressing weight, holding time, and/or the distance of the touching object.

Additionally, the touch panel can function as a normal joystick, suitable for flexible user interface (“UI”) requirements, or even for web browsing. Referring to FIG. 7, the first area 72 can be a designated button, where a detected object touching or in close proximity to the first area 72 can signal a button press. The second area 74 can be used to receive joystick commands to move a cursor or other corresponding display element on a display screen. The contact metric can also be used to determine the velocity and/or acceleration of the cursor movement. Thus, if the object has more contact acreage on the second area 74, the cursor movement can accelerate faster than if there is less contact acreage.

In addition to the various modes of operation, a released state and an operating state can be implemented to differentiate when the user is operating the touch panel and when the user is not operating the touch panel.

When the user's finger is resting on the touch panel with a small contact acreage in between the finger and the surface of the touch panel, the contact metric W will be small. For this situation, the touch panel can be in a released state, where the user is not actively inputting commands to the touch panel. The determination of the released state can be by defining a first contact metric threshold (e.g., 2.5 pF) for determining the state of the touch panel. If the contact metric for the finger is below this threshold, then the touch panel can be set to the released state. However, if the contact metric for the finger meets or exceeds the first contact metric threshold, the touch panel can be set to an operating state, where the touch panel periodically scans for user input on the touch panel. Furthermore, a suitable software filter can be employed for anti-shocking purposes.

Also, an amount of time may be required to maintain the contact metric at or above the first contact metric threshold to confirm that the user wants to place the touch panel in the operating state. For instance, the contact metric may be required to be less than or equal to 2.5 pF for a predefined number of continuous scanning periods of around 5 scans (which can be around 50 ms). For such a case, the released state is confirmed. The touch panel can be kept in the released state until an operating state is signaled.

In another embodiment of the present invention, multiple contact metric thresholds can be used for determining the operating mode of the touch panel. When a contact metric for a detected object is below a first contact metric threshold (e.g., 2.5 pF), the touch panel can be set to the released state. A second contact metric threshold (e.g., 5 pF) that is greater than the first contact metric threshold can be defined for the operating state of the touch panel. Thus, in order for the touch panel to receive user input, the detected object must meet or exceed the second contact metric threshold. Once again, a suitable software filter can be used for anti-shocking purposes.

The software filter can prevent accidental brushes to the touch panel from activating the touch panel. Additionally, the software filter can account for noise from the controller of touch panel, where the power and/or ground to the controller may cause noise during the capacitance measurement. Thus, the software filter can smooth out this noise.

Furthermore, an amount of time/cycles may be required to maintain the contact metric at or above one of the contact metric thresholds to change from one state to another state. For instance, the contact metric may be required to be more than or equal to 5 pF for a predefined number of continuous scans (e.g., 5 times, which can be around 50 ms). Thus, the operating state is confirmed. Similarly, the operating state is maintained until the amount of time required for the released state is detected.

Having an operating state and a released state allows the user to keep his/her finger laid on the cover's surface, regardless of whether the user is operating the touch panel or not. The user does not have to re-locate his/her finger each time the user wishes to operate the touch panel. Consequently, the user does not have to avert his/her eyes from the display screen to reinitiate contact with the active detection area of the touch panel since the finger can be positioned on the active detection area.

The touch panel of the present invention having joystick capabilities can be suitable for many devices, such as digital picture frames (“DPF”), electronic books (“e-Book”), television (“TV”) remote controllers, and other devices where a touch panel can be used. Furthermore, the touch panel can serve as an easy interface to hold the associated device since the user can securely hold the device in the user's hand without having to worry about accidental user inputs to the touch panel.

Each time the touch panel enters an operating state from a released state, the default operating type is button-oriented, where a distance d for a detected object is not used (and therefore may not be calculated). The detected object's distance d can be considered valid by setting a suitable contact metric threshold for determining whether the detected object's distance is valid. Furthermore, a suitable software filter for anti-shocking can be used to determine whether an accidental activation was initiated.

Additionally, the touch panel may switch between various modes of operation. For instance, the touch panel may switch between a button mode, a sliding mode, and a combination mode (e.g., a joystick mode).

In an embodiment of the present invention, a button mode can be activated by touching the touch panel in area 72 such that the location is considered invalid. When the detected object is sensed at the area 74, the operating mode can be changed to a sliding mode, where a valid vector is calculated for the detected object.

Additionally, since W has a much higher resolution (200 distinct levels for the previous example) than d (8 distinct levels for the previous example), W can be used to distinguish between a multitude of operating modes (e.g., button mode, sliding mode, combinations thereof, or other operating modes) and user input commands. The contact metric W can also be monitored for a period of time to alter the user input. For example, if the contact metric W is maintained at around 5 pF, the sliding speed can be set at 5 display pixels for the 1st second that W is maintained, 6 pixels in the 2nd second, 8 pixels in the 3rd second, 11 pixels in the 4th second, 15 pixels in the 5th second, and so forth. Furthermore, other sliding speed schemes for moving the display element can be implemented as desired.

In addition, the sliding speed of the display element can be a function of the distance d of the object on the touch panel. For instance, as the distance d increases, the speed of the display element may also increase accordingly. Furthermore, the value of d may correspond to a predefined speed of the display element. Thus, each distinct value of d may correspond to a distinct value for the speed of the display element.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for operating a touch panel, comprising the steps of:
sensing an object in proximity to the touch panel;
determining a location on the touch panel corresponding to the sensed object;
determining a contact metric indicative of an amount of pressure applied on the touch panel by the sensed object; and
operating the touch panel as a function of the location and the contact metric.

2. The method of claim 1 wherein the location comprises an angle and a distance and wherein the angle and the distance are calculated from a predefined position on the touch panel.

3. The method of claim 2 wherein a display element moves in a direction that is a function of the angle.

4. The method of claim 2 wherein a display element moves at a speed that is a function of the distance.

5. The method of claim 1 wherein a display element moves at a speed that is a function of the contact metric.

6. The method of claim 1 wherein the touch panel is implemented by capacitance channels and wherein the contact metric is calculated by summing capacitances detected by the capacitance channels.

7. The method of claim 1 wherein the touch panel has an active detection area and wherein the active detection area is partitioned into a plurality of areas.

8. The method of claim 7 wherein one of the partitioned areas provide for joystick capabilities.

9. The method of claim 7 wherein one of the partitioned areas provide for a button capability.

10. The method of claim 1 wherein if the contact metric is below a first contact metric threshold, then the touch panel is placed in a released state.

11. The method of claim 1 wherein if the contact metric meets or exceeds a second contact metric threshold, then the touch panel is placed in an operating state.

12. A method for operating a touch panel, comprising the steps of:
sensing an object in proximity to the touch panel;
determining a location on the touch panel corresponding to the sensed object, wherein the location comprises an angle and a distance and wherein the angle and the distance are calculated from a predefined position on the touch panel;
determining a contact metric indicative of an amount of pressure applied on the touch panel by the sensed object; and
operating the touch panel as a function of the location and the contact metric,
wherein a display element moves in a direction that is a function of the angle, and
wherein a display element moves at a speed that is a function of the distance and the contact metric.

13. The method of claim 12 wherein the touch panel is implemented by capacitance channels and wherein the contact metric is calculated by summing capacitances detected by the capacitance channels.

14. The method of claim 12 wherein the touch panel has an active detection area and wherein the active detection area is partitioned into a plurality of areas.

15. The method of claim 14 wherein one of the partitioned areas provide for joystick capabilities.

16. The method of claim 14 wherein one of the partitioned areas provide for a button capability.

17. The method of claim 12 wherein if the contact metric is below a first contact metric threshold, then the touch panel is placed in a released state.

18. The method of claim 12 wherein if the contact metric meets or exceeds a second contact metric threshold, then the touch panel is placed in an operating state.

19. A method for operating a touch panel, comprising the steps of:
sensing an object in proximity to the touch panel;
determining a location on the touch panel corresponding to the sensed object, wherein the location comprises an angle and a distance and wherein the angle and the distance are calculated from a predefined position on the touch panel;
determining a contact metric indicative of an amount of pressure applied on the touch panel by the sensed object, wherein the touch panel is implemented by capacitance channels and wherein the contact metric is calculated by summing capacitances detected by the capacitance channels; and
operating the touch panel according to the location and the contact metric,
wherein a display element moves in a direction that is a function of the angle,
wherein a display element moves at a speed that is a function of the distance and the contact metric,
wherein the touch panel has an active detection area and wherein the active detection area is partitioned into a plurality of areas,
wherein one of the partitioned areas provide for joystick capabilities, and
wherein one of the partitioned areas provide for a button capability.

20. The method of claim 1 wherein a first contact metric threshold is smaller than a second contact metric threshold, wherein if the contact metric is below the first contact metric threshold, then the touch panel is placed in a released state and wherein if the contact metric meets or exceeds the second contact metric threshold, then the touch panel is placed in an operating state.
